(19) United States
(12) Patent Application Publication
(10) Pub. No.: US 2023/0303070 A1
(43) Pub. Date: Sep. 28, 2023

(54) DIVISION LINE RECOGNITION APPARATUS

(71) Applicant: Honda Motor Co., Ltd., Tokyo (JP)

(72) Inventors: Yuki Aoyagi, Wako-shi (JP); Yuhi Goto, Wako-shi (JP); Yuichi Konishi, Wako-shi (JP)

(21) Appl. No.: 18/124,492

(22) Filed: Mar. 21, 2023

(30) Foreign Application Priority Data
Mar. 28, 2022 (JP) 2022-051916

(51) Int. Cl. B60W 30/12

(52) U.S. Cl. CPC B60W 30/12; B60W 2552/53

(57) ABSTRACT

Division line recognition apparatus includes: external sensor mounted on vehicle and detecting external situation in front of vehicle; behavior sensor detecting traveling behavior of vehicle; and electronic control unit performing: storing posture information of external sensor with respect to vehicle; recognizing division line defining travel lane along which vehicle travels based on external situation detected by external sensor and posture information; calculating movement amount of vehicle from first time point to second time point based on traveling behavior detected by behavior sensor; setting inspection point on division line recognized at second time point; calculating error of position of division line recognized at first time point with respect to position of inspection point based on movement amount; and updating posture information based on error. Recognizing includes recognizing division line based on external situation detected by external sensor and updated posture information when posture information is updated.

### CROSS-REFERENCE TO RELATED APPLICATION

This application is based upon and claims the benefit of priority from Japanese Patent Application No. 2022-051916 filed on Mar. 28, 2022, the content of which is incorporated herein by reference.

### BACKGROUND OF THE INVENTION

### Field of the Invention

This invention relates to a division line recognition apparatus configured to recognize division lines which defines a travel lane along which a vehicle having an automatic driving function or a driving-assistance function travels.

### Description of the Related Art

As this type of device, there has been conventionally known a device configured to monitor the surroundings by a camera mounted on a vehicle (see, for example, JP 2020-068477 A). In the device described in JP 2020-068477 A, the actual installation posture of the camera is estimated on the basis of a first vector corresponding to the advancing direction of the vehicle and a second vector corresponding to the normal direction of a road surface, and the camera is calibrated.

As vehicles each having an automatic driving function and a driving-assistance function become widely used, the safety and convenience of the entire traffic society are improved, and a sustainable transportation system is achievable. In addition, as the efficiency and smoothness of transportation are improved, CO₂ emission amounts are reduced, and loads on the environment can be reduced.

Incidentally, in a case where automatic driving or driving assistance is performed, a division line on a forward side of the vehicle is recognized on the basis of an external detection result by a camera or the like, and travel control of the vehicle is performed on the basis of the recognition result of the division line. Therefore, it is preferable to make it possible to accurately recognize not only a division line located at a short distance from the vehicle but also a division line located at a long distance from the vehicle. However, when the camera is calibrated as in the device described in JP 2020-068477 A, it is difficult to accurately recognize a division line located at a long distance from the vehicle.

### SUMMARY OF THE INVENTION

An aspect of the present invention is a division line recognition apparatus, including: an external sensor mounted on a vehicle and configured to detect an external situation in front of the vehicle; a behavior sensor configured to detect a traveling behavior of the vehicle; and an electronic control unit including a processor and a memory coupled to the processor. The electronic control unit is configured to perform: storing posture information of the external sensor with respect to the vehicle; recognizing a division line defining a travel lane along which the vehicle travels based on the external situation detected by the external sensor and the posture information; calculating a movement amount of the vehicle from a first time point to a second time point based on the traveling behavior detected by the behavior sensor; setting an inspection point on the division line recognized at the second time point; calculating an error of a position of the division line recognized at the first time point with respect to a position of the inspection point based on the movement amount; and updating the posture information based on the error. The recognizing includes recognizing the division line based on the external situation detected by the external sensor and the updated posture information when the posture information is updated.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a configuration of main components and a processing flow of a division line recognition apparatus according to an embodiment of the present invention;

FIG. 2 is a diagram for describing recognition of a division line by a division line recognition unit of FIG. 1 and setting of an inspection point by an inspection point setting unit of FIG. 1;

FIG. 3 is a diagram for describing calculation of an error by an error calculation unit of FIG. 1;

FIG. 4 is a diagram illustrating an example of frequency distribution of the error calculated by the error calculation unit of FIG. 1 and stored in a storage unit of FIG. 1;

FIG. 5A is a conceptual diagram for describing update of posture information by a posture information update unit of FIG. 1, when an attachment angle of an external sensor in a yaw direction in the posture information is deviated; and

FIG. 5B is a conceptual diagram for describing update of the posture information by the posture information update unit of FIG. 1, when an attachment angle of the external sensor in a pitch direction in the posture information is deviated.

### DETAILED DESCRIPTION OF THE INVENTION

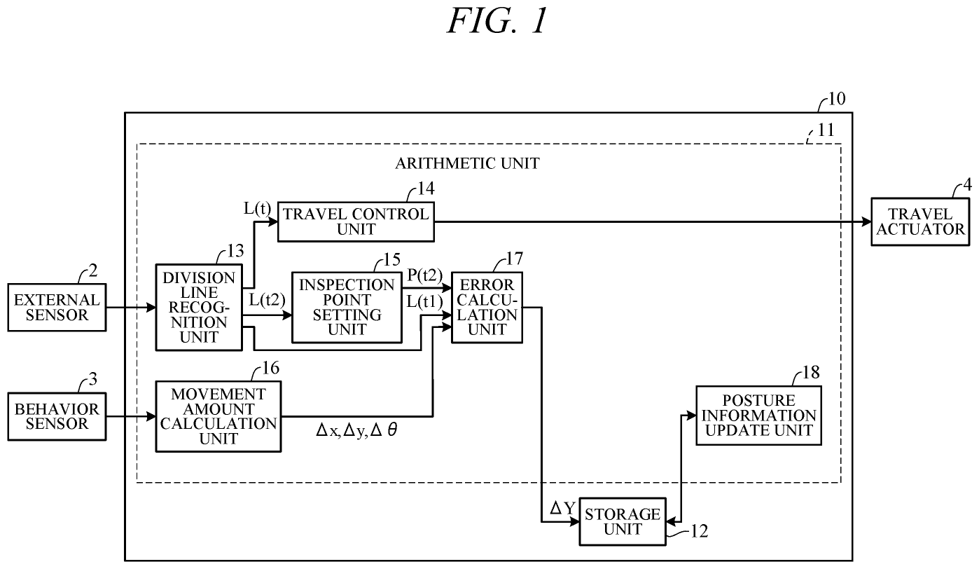

Hereinafter, embodiments of the present invention will be described with reference to FIGS. 1 to 5B. A division line recognition apparatus according to an embodiment of the present invention is applied to a vehicle having a driving-assistance function of controlling a travel actuator to perform driving assistance for a driver of the vehicle or to automatically drive the vehicle, and recognizes a division line which defines a travel lane along which the vehicle travels. The “driving assistance” in the present embodiment includes driving assistance for assisting driver's driving operations and automatic driving for automatically driving a vehicle without depending on the driver's driving operations, and corresponds to levels 1 to 4 of driving automation defined by SAE, and the “automatic driving” corresponds to the level 5 driving automation.

During driving assistance or automatic driving, a traveling behavior, such as a traveling speed and an advancing direction of the vehicle, and an external situation on a forward side of the vehicle are detected at a predetermined cycle, a target travel route of the vehicle is generated in accordance with detection results, and the vehicle is controlled to travel along the target travel route that has been generated. External sensors, such as a camera and a LiDAR, which detect the external situation are attached to the vehicle at a predetermined position and angle (posture) at the time of manufacturing the vehicle or the like. The position of an external object including a division line can be estimated and recognized on the basis of a detection result by the external sensor in consideration of posture information of the external sensor with respect to such a vehicle. In addition, for a moving object such as another vehicle or a pedestrian among external objects, a moving speed can be estimated by time-differentiating the estimated position.

However, when there is a deviation between the posture information and an actual posture, the position of the external object including the division line cannot be accurately estimated. In particular, when the attachment angle of the external sensor deviates even slightly, the estimation accuracy of the position of the division line located at a long distance from the vehicle decreases, and it becomes difficult to appropriately generate a target travel route from the vehicle to the long distance. In this regard, in the present embodiment, a division line recognition apparatus is configured as follows such that it is possible to accurately recognize a division line located at a long distance from the vehicle by updating posture information of external sensor to eliminate such an error.

FIG. 1 is a block diagram schematically illustrating an example of a configuration of main components and a processing flow of a division line recognition apparatus (hereinafter, an apparatus) 100 according to an embodiment of the present invention. As illustrated in FIG. 1, the apparatus 100 mainly includes an electronic control unit (ECU) 10. The ECU 10 includes a computer including an arithmetic unit 11 such as a CPU, a storage unit 12 such as a RAM and a ROM, an I/O interface, and other peripheral circuits. The ECU 10 is configured, for example, as a part of a plurality of ECU groups that are mounted on a vehicle 1 and that control the operation of the vehicle 1. The processing of FIG. 1 is started, for example, when the vehicle 1 is started or activated and the ECU 10 is activated, and is repeated at a predetermined cycle.

An external sensor 2 which is mounted on the vehicle 1 and detects an external situation in front of the vehicle 1, a behavior sensor 3 which detects a traveling behavior of the vehicle 1, and a travel actuator 4 are connected to the ECU 10.

The external sensor 2 detects an external situation on a forward side of the vehicle with an advancing direction of the vehicle 1 as the center. The external sensor 2 includes, for example, an imaging element such as a CCD or a CMOS, and includes a camera that images a forward side of the vehicle. The external sensor 2 may include a LiDAR that irradiates laser light, measures a distance and a direction to an object by use of a period of time until the irradiated light hits the object and then returns, and detects reflection luminance at each measurement point.

The behavior sensor 3 detects a traveling behavior such as a traveling speed and an advancing direction of the vehicle 1. The behavior sensor 3 includes, for example, a wheel speed sensor that detects a rotation speed of each wheel of the vehicle 1. The behavior sensor 3 may include a yaw rate sensor that detects a rotation angular velocity (yaw rate) around a vertical axis of the center of gravity of the vehicle 1, a positioning unit that measures an absolute position (latitude, longitude) of the vehicle 1 on the basis of a positioning signal from a positioning satellite, and the like.

The travel actuator 4 includes a steering mechanism such as a steering gear that steers the vehicle 1, a driving mechanism such as an engine or a motor that drives the vehicle 1, and a braking mechanism such as a brake that applies the brakes of the vehicle 1.

The ECU 10 includes, as a functional configuration of the arithmetic unit, a division line recognition unit 13, a travel control unit 14, an inspection point setting unit 15, a movement amount calculation unit 16, an error calculation unit 17, and a posture information update unit 18. That is, the arithmetic unit 11 of the ECU 10 functions as the division line recognition unit 13, the travel control unit 14, the inspection point setting unit 15, the movement amount calculation unit 16, the error calculation unit 17, and the posture information update unit 18. The storage unit 12 stores posture information of the external sensor 2 with respect to the vehicle 1.

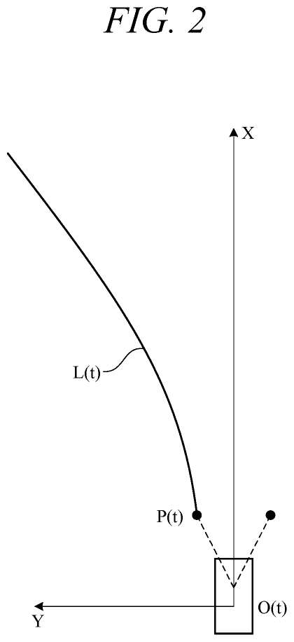

FIG. 2 is a diagram for describing the recognition of the division line by the division line recognition unit 13 and the setting of the inspection point by the inspection point setting unit 15, and illustrates an example of a division line L(t) recognized by the division line recognition unit 13 at a time point t and an inspection point P(t) set by the inspection point setting unit 15. Note that in each drawing, the right division line L(t) is omitted for convenience.

As illustrated in FIG. 2, on the basis of the external situation detected by the external sensor 2 and the posture information stored in the storage unit 12, the division line recognition unit 13 recognizes the division line L(t) that defines a travel lane along which the vehicle 1 travels. More specifically, a coordinate system is set in which the current position of the vehicle 1 is an origin O(t), the advancing direction of the vehicle 1 is an X axis, and a vehicle width direction is a Y axis, and the position coordinates of the division line L(t) in the set coordinate system are estimated.

The division line recognition unit 13 may specify a high-order function such as a cubic function that approximates the recognized division line L(t) by using a curve fitting method such as a least squares method. A typical road shape is designed with a clothoid curve in which the curvature changes at a certain rate, and some sections of the clothoid curve corresponding to the road shape can be approximated by use of a high-order function such as a cubic function.

The recognition of the division line L(t) by the division line recognition unit 13 is performed, for example, for each control cycle of the ECU 10. The division line L(t) recognized by the division line recognition unit 13 is stored, in the storage unit 12, as the position coordinates of a point group configuring the division line L(t) or as a function that approximates the division line L(t).

The travel control unit 14 controls the travel actuator 4 on the basis of the recognition result by the division line recognition unit 13. For example, the target travel route of the vehicle 1 is generated to pass through the center of the left and right division lines L(t) recognized by the division line recognition unit 13, and the travel actuator 4 is controlled so that the vehicle 1 travels along the generated target travel route.

The inspection point setting unit 15 sets the inspection point P(t) on the division line L(t) recognized by the division line recognition unit 13. More specifically, as illustrated in FIG. 2, the inspection point P(t) is set at a short distance within a predetermined distance from the current position of the vehicle 1, for example, 5 m ahead of the current position of the vehicle 1. The inspection point setting unit 15 may set, as the inspection point P(t), a point closest to the vehicle 1 on the division line L(t) detected by the external sensor 2 and recognized by the division line recognition unit 13.

At the current position of the vehicle 1, that is, at a short distance within a predetermined distance from the current position of the external sensor 2, even when the attachment angle of the external sensor 2 in the posture information stored in the storage unit 12 is slightly deviated, the division line L(t) can be recognized with relatively high accuracy. The inspection point setting unit 15 sets the inspection point P(t) for each control cycle of the ECU 10, for example.

The movement amount calculation unit 16 calculates the movement amount of the vehicle 1 from a first time point t1 to a second time point t2 on the basis of the traveling behavior detected by the behavior sensor 3. More specifically, the translational movement amount (Δx,Δy) and the rotational movement amount Δθ of the vehicle 1 from the first time point t1 to the second time point t2 are calculated. In other words, the translational movement amount (Δx,Δy) and the rotational movement amount Δθ in the coordinate system of FIG. 2 from the first time point t1 to the second time point t2 are calculated.

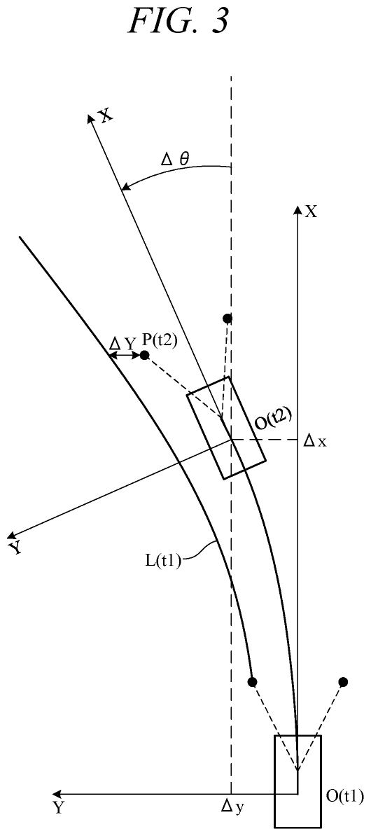

FIG. 3 is a diagram for describing the calculation of the error by the error calculation unit 17, and illustrates an example of the division line L(t1) recognized by the division line recognition unit 13 at the first time point t1 and the inspection point P(t2) set by the inspection point setting unit 15 at the second time point t2. As illustrated in FIG. 3, the error calculation unit 17 first converts the coordinate system of the second time point t2 into the coordinate system of the first time point t1 on the basis of the translational movement amount (Δx,Δy) and the rotational movement amount Δθ calculated by the movement amount calculation unit 16.

Next, the error calculation unit 17 calculates an error of the position of the division line L(t1) recognized by the division line recognition unit 13 at the first time point t1, more specifically an error ΔY of a Y coordinate, with respect to the position of the inspection point P(t2) set by the inspection point setting unit 15 at the second time point t2. The error ΔY calculated by the error calculation unit 17 is stored and accumulated in the storage unit 12.

The calculation processing by the movement amount calculation unit 16 and the error calculation unit 17 is performed on a plurality of combinations of the first time point t1 and the second time point t2 for each control cycle of the ECU 10, for example. More specifically, the combination of the first time point t1 and the second time point t2 is sequentially changed to a combination in which the previous control cycle is set to the first time point t1 and the current control cycle is set to the second time point t2 and a combination in which the previous-to-previous control cycle is set to the first time point t1 and the current control cycle is set to the second time point t2, and is performed. In other words, the calculation processing by the movement amount calculation unit 16 and the error calculation unit 17 is performed by setting a specific control cycle to the first time point t1 and sequentially setting control cycles subsequent to the specific control cycle to the second time point t2.

The combination of the first time point t1 and the second time point t2 is changed, for example, until the vehicle 1 travels a predetermined distance (for example, 100 m) in a period from the first time point t1 to the second time point t2. In other words, the calculation processing by the movement amount calculation unit 16 and the error calculation unit 17 is performed by sequentially setting the control cycles subsequent to the specific control cycle to the second time point t2 until the vehicle 1 travels a predetermined distance from the first time point t1 to the second time point t2.

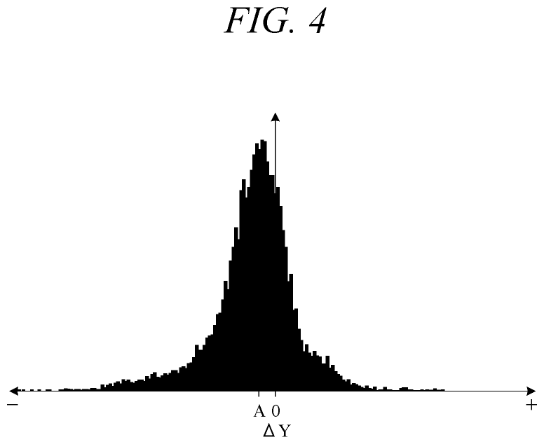

FIG. 4 is a diagram illustrating an example of the frequency distribution of the error ΔY calculated by the error calculation unit 17 and stored and accumulated in the storage unit 12, and illustrates an example of the frequency distribution of the error ΔY when the time points before and after the vehicle 1 travels a predetermined distance D (for example, 50 m) are set as the first time point t1 and the second time point t2. The posture information update unit 18 updates the posture information stored in the storage unit 12 on the basis of the error ΔY calculated by the error calculation unit 17 and stored in the storage unit 12. For example, the posture information is updated such that an average value A of the errors ΔY which are calculated by the error calculation unit 17 at a long distance that is a predetermined distance D (for example, 50 m) ahead from the vehicle 1 as illustrated in FIG. 4 converges to “0”. The update of the posture information by the posture information update unit 18 may be performed on the basis of a predetermined characteristic according to the magnitude of the error ΔY, may be performed on the basis of a change rate of the error ΔY by a gradient method or the like, or may be performed by other optimization methods.

The update of the posture information by the posture information update unit 18 is performed on condition that the arithmetic load of the travel control unit 14 is equal to or less than a predetermined value, for example, during the stop or halt of an engine or a travel motor, for example, immediately after the start (activation) of the vehicle 1 or during hands-on time when automatic driving is not performed. When the posture information is updated by the posture information update unit 18, the division line recognition unit 13 recognizes the division line L(t) on the basis of the external situation detected by the external sensor 2 and the updated posture information.

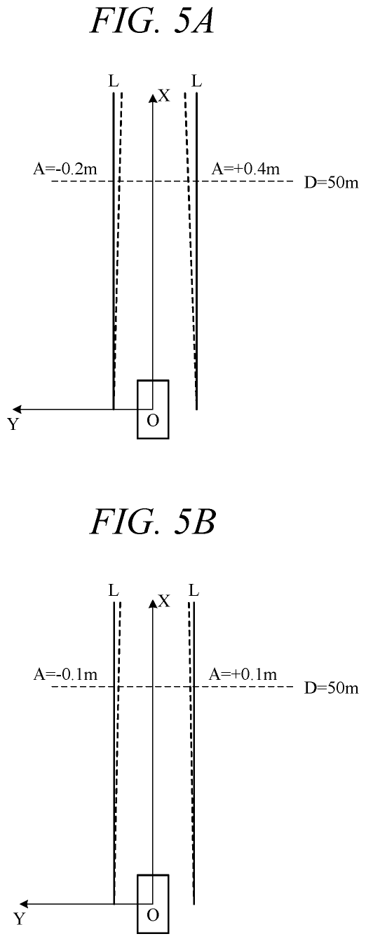

FIGS. 5A and 5B are conceptual diagrams for describing the update of the posture information by the posture information update unit 18, actual left and right division lines L are indicated by solid lines, and the left and right division lines L recognized by the division line recognition unit 13 are indicated by broken lines. In addition, the average value A of the errors ΔY, which are calculated by the error calculation unit 17 at a long distance that is the predetermined distance D (50 m in the drawing) ahead, with respect to the left and right division lines L is illustrated.

In the example of FIG. 5A, the recognition result of the left division line L 50 m ahead is deviated to the inside of the travel lane by 0.2 m, and the recognition result of the right division line L is deviated to the inside of the travel lane by 0.4 m. As described above, in a case where the deviation amounts of the recognition results of the division lines L on the left and right sides do not coincide with each other, the information of the attachment angle of the external sensor 2 in a yaw direction with respect to the vehicle 1 in the posture information stored in the storage unit 12 is deviated from an actual attachment angle. In the example of FIG. 5A, the attachment angle is deviated rightward from the actual attachment angle.

In such a case, the posture information update unit 18 corrects the attachment angle of the external sensor 2 in the posture information such that the recognition results of the left and right division lines L 50 m ahead are deviated rightward by 0.1 m and both the left and right division lines L are deviated to the inside of the travel lane by 0.3 m. More specifically, the posture information update unit 18 corrects the attachment angle of the external sensor 2 leftward by tan −1(0.1/50)=0.115 deg and updates the posture information stored in the storage unit 12. As a result, the deviation of the attachment angle of the external sensor 2 in the yaw direction in the posture information is eliminated.

In the example of FIG. 5B, both the recognition results of the left and right division lines L 50 m ahead are deviated to the inside of the travel lane by 0.1 m. As described above, in a case where the recognition result of the division line L is deviated to the inside of the travel lane, the information of the attachment angle of the external sensor 2 in a pitch direction with respect to the vehicle 1 in the posture information stored in the storage unit 12 is deviated downward from the actual attachment angle.

In such a case, the posture information update unit 18 corrects the attachment angle of the external sensor 2 in the posture information such that the recognition result of the division line L 50 m ahead is deviated downward by 0.1 m and the deviation of the recognition result is eliminated. More specifically, the posture information update unit 18 corrects the attachment angle of the external sensor 2 upward by tan −1 (0.1/50)=0.115 deg and updates the posture information stored in the storage unit 12. As a result, the deviation of the attachment angle of the external sensor 2 in the pitch direction in the posture information is eliminated.

The present embodiment is capable of achieving the following operations and effects.

(1) The apparatus 100 includes: the external sensor 2 that is mounted on the vehicle 1 and detects an external situation in front of the vehicle 1; the behavior sensor 3 that detects a traveling behavior of the vehicle 1; the storage unit 12 that stores the posture information of the external sensor 2 with respect to the vehicle 1; the division line recognition unit 13 that recognizes the division line L(t), which defines a travel lane along which the vehicle 1 travels, on the basis of the external situation detected by the external sensor 2 and the posture information stored in the storage unit 12; the movement amount calculation unit 16 that calculates a translational movement amount (Δx,Δy) and a rotational movement amount Δθ of the vehicle 1 from the first time point t1 to the second time point t2 on the basis of the traveling behavior detected by the behavior sensor 3; the inspection point setting unit 15 that sets an inspection point P(t2) on the division line L(t2) recognized by the division line recognition unit 13 at the second time point t2; the error calculation unit 17 that calculates an error ΔY of the position of the division line L(t1) recognized by the division line recognition unit 13 at the first time point t1 with respect to the position of the inspection point P(t2) set by the inspection point setting unit on the basis of the translational movement amount (Δx,Δy) and the rotational movement amount Δθ calculated by the movement amount calculation unit 16; and the posture information update unit 18 that updates the posture information stored in the storage unit 12 on the basis of the error ΔY calculated by the error calculation unit 17 (FIG. 1).

When the posture information is updated by the posture information update unit 18, the division line recognition unit 13 recognizes the division line L(t) on the basis of the external situation detected by the external sensor 2 and the updated posture information. That is, an error of the result of recognition at a long distance with respect to the result of recognition at a short distance with relatively high accuracy is calculated via the movement amount of the vehicle 1 calculated by the behavior sensor 3 such as the wheel speed sensor, the yaw rate sensor, and the positioning unit, and the external sensor 2 is self-calibrated on the basis of the calculated error. As a result, since the external sensor 2 can be self-calibrated with high accuracy, it is possible to accurately estimate and recognize the position of the division line L located at a long distance from the vehicle 1. In addition, it is possible to estimate and recognize the position of an external object other than the division line L with high accuracy in the same manner, and it is possible to estimate the moving speed of a moving object such as another vehicle or a pedestrian with high accuracy.

(2) The storage unit 12 further stores the error ΔY in a predetermined period calculated by the error calculation unit 17. The posture information update unit 18 updates the posture information stored in the storage unit 12 on the basis of the error ΔY in the predetermined period stored in the storage unit 12 (FIG. 4). As described above, by accumulating the error information over a certain period and using statistical information, the external sensor 2 can be self-calibrated with higher accuracy.

(3) The apparatus 100 further includes the travel control unit 14 that controls the travel actuator 4 on the basis of the recognition result by the division line recognition unit 13 (FIG. 1). The posture information update unit 18 updates the posture information stored in the storage unit 12 on condition that the arithmetic load of the travel control unit 14 is equal to or less than a predetermined value. As a result, it is possible to suppress the influence of the calibration processing of the external sensor 2 on the travel control.

(4) The inspection point setting unit 15 sets an inspection point P within a predetermined distance (for example, 5 m ahead) from the vehicle 1. As described above, since the result of recognition at a short distance with relatively high accuracy is used, the external sensor 2 can be self-calibrated with high accuracy.

(5) The posture information update unit 18 updates the posture information stored in the storage unit 12 such that the error ΔY calculated by the error calculation unit 17 at a predetermined distance D (for example, 50 m) ahead of the vehicle 1 is eliminated. As described above, since the external sensor 2 is self-calibrated to eliminate the error in the result of recognition at a long distance, the accuracy of recognition of the division line L located at a long distance from the vehicle 1 can be reliably improved.

(6) The division line recognition unit 13 sets a coordinate system in which the advancing direction of the vehicle 1 is an X axis and the vehicle width direction is a Y axis, and recognizes the position coordinates of the division line L(t) in the set coordinate system (FIG. 2). The error calculation unit 17 calculates an error ΔY of the Y coordinate of the position of the division line L(t1) recognized by the division line recognition unit 13 at the first time point with respect to the position of the inspection point P(t2) set by the inspection point setting unit 15 in the coordinate system set by the division line recognition unit 13 at the first time point (FIG. 3).

As described above, by quantifying the error in the vehicle width direction, it is possible to clarify whether the recognition result of the division line L is generated inside or outside the travel lane, and to clarify in which direction the attachment angle of the external sensor 2 with respect to the vehicle 1 in the posture information is to be corrected. In addition, it is possible to effectively eliminate an error in the recognition result of the division line L generated in the vehicle width direction.

In the above embodiment, an example has been described in which the calculation processing by the movement amount calculation unit 16 and the error calculation unit 17 is performed by sequentially changing the combination of the first time point t1 and the second time point t2, but the movement amount calculation unit and the error calculation unit are not limited to such an example. For example, the time points before and after the vehicle 1 travels a predetermined distance (for example, 50 m) may be set as the first time point t1 and the second time point t2.

In the above embodiment, an example has been described in which the inspection point setting unit 15 sets the inspection point P(t) 5 m ahead of the current position of the vehicle 1, but the inspection point set by the inspection point setting unit is not limited to such an example. The inspection point may be set in any manner as long as the inspection point is set at a short distance within a predetermined distance from the current position of the vehicle 1 where the external sensor 2 can accurately recognize the division line L.

In the above embodiment, an example in which the error calculation unit 17 calculates the error ΔY in the Y-axis direction corresponding to the vehicle width direction of the first time point t1 has been described with reference to FIG. 3 and the like, but the error calculated by the error calculation unit is not limited to such an example. For example, an error in the Y-axis direction corresponding to the vehicle width direction of the second time point t2 may be calculated. In a case where the division line L(t1) recognized at the first time point t1 is specified as a function, a distance between the inspection point P(t2) and the division line L(t1) may be calculated as an error. In a case where the division line L(t1) recognized at the first time point t1 is specified as a point group, the shortest distance between the inspection point P(t2) and the point group configuring the division line L(t1) may be calculated as an error.

In the above embodiment, an example has been described in which the posture information update unit 18 updates the posture information to eliminate the error ΔY 50 m ahead of the vehicle 1, but the update of the posture information by the posture information update unit is not limited to such an example. The predetermined distance D for eliminating an error may be set in any manner as long as the predetermined distance is set in a range necessary for performing smooth traveling control and in a range in which the recognition accuracy of the external sensor 2 decreases.

The above embodiment can be combined as desired with one or more of the aforesaid modifications. The modifications can also be combined with one another.

According to the present invention, it is possible to accurately recognize a division line located at a long distance from a vehicle.

Above, while the present invention has been described with reference to the preferred embodiments thereof, it will be understood, by those skilled in the art, that various changes and modifications may be made thereto without departing from the scope of the appended claims.

1. A division line recognition apparatus, comprising:
an external sensor mounted on a vehicle and configured to detect an external situation in front of the vehicle;
a behavior sensor configured to detect a traveling behavior of the vehicle; and
an electronic control unit including a processor and a memory coupled to the processor, wherein
the electronic control unit is configured to perform:
storing posture information of the external sensor with respect to the vehicle;
recognizing a division line defining a travel lane along which the vehicle travels based on the external situation detected by the external sensor and the posture information;
calculating a movement amount of the vehicle from a first time point to a second time point based on the traveling behavior detected by the behavior sensor;
setting an inspection point on the division line recognized at the second time point;
calculating an error of a position of the division line recognized at the first time point with respect to a position of the inspection point based on the movement amount; and
updating the posture information based on the error, wherein
the recognizing includes recognizing the division line based on the external situation detected by the external sensor and the updated posture information when the posture information is updated.

2. The division line recognition apparatus according to claim 1, wherein
the storing includes further storing the error in a predetermined period, wherein
the updating includes updating the posture information based on the error in the predetermined period.

3. The division line recognition apparatus according to claim 2, wherein
the electronic control unit is further configured to perform:
controlling a travel actuator based on the recognized division line, wherein
the updating includes updating the posture information on condition that an arithmetic load of the controlling is equal to or less than a predetermined value.

4. The division line recognition apparatus according to claim 1, wherein
the setting includes setting the inspection point within a predetermined distance from the vehicle.

5. The division line recognition apparatus according to claim 4, wherein
the setting includes setting a point closest to the vehicle on the recognized division line as the inspection point.

6. The division line recognition apparatus according to claim 4, wherein
the predetermined distance is a first predetermined distance, wherein
the updating includes updating the posture information such that the error at a second predetermined distance ahead of the vehicle is eliminated, the second predetermined distance being longer than the first predetermined distance.

7. The division line recognition apparatus according to claim 1, wherein
the recognizing includes:
setting a coordinate system in which an advancing direction of the vehicle is an X axis and a vehicle width direction is a Y axis; and
recognizing position coordinates of the division line in the set coordinate system, wherein
the calculating the error includes calculating an error of the Y coordinate of the position of the division line recognized at the first time point with respect to the position of the inspection point set in the coordinate system set at the first time point.

8. The division line recognition apparatus according to claim 1, wherein
the calculating the movement amount includes calculating a translational movement amount and a rotational movement amount of the vehicle from the first time point to the second time point based on the traveling behavior detected by the behavior sensor.

9. The division line recognition apparatus according to claim 1, wherein
the calculating the movement amount and the error includes:
setting a specific control cycle of the electronic control unit to the first time point and sequentially setting control cycles subsequent to the specific control cycle to the second time point; and
calculating the movement amount and the error.

10. The division line recognition apparatus according to claim 9, wherein
the calculating the movement amount and the error includes:
sequentially setting the control cycles subsequent to the specific control cycle to the second time point until the vehicle travels a predetermined distance from the first time point to the second time point; and
calculating the movement amount and the error.
